(19) United States
(12) Patent Application Publication
(10) Pub. No.: US 2008/0211715 A1
(43) Pub. Date: Sep. 4, 2008

(54) GLOBAL POSITIONING SYSTEM USING BROADBAND NOISE REDUCTION

(75) Inventors: Paul L. FEINTUCH, San Dimas, CA (US); Ronald A. BORRELL, Corona, CA (US); Anthony SAGLEMBENI, Ladera Ranch, CA (US); Joshua G. SLATER, Orange, CA (US)

Correspondence Address: MCNEES WALLACE & NURICK LLC, 100 PINE STREET, P.O. BOX 1166, HARRISBURG, PA, 17108-1166, US

(73) Assignees: TECHNOLOGY FOCUS LLC, San Dimas, CA (US); CORNERTURN LLC, Corona, CA (US)

(21) Appl. No.: 11/839,616

(22) Filed: Aug. 16, 2007

Related U.S. Application Data
(60) Provisional application No. 60/838,258, filed on Aug. 17, 2006.

(51) Int. Cl. G01S 1/00

(52) U.S. Cl. 342/357.12

(57) ABSTRACT

The present invention is directed to a global positioning system (GPS) having improved signal-to-noise ratio for reducing the required signal level for which GPS may be implemented in electronic devices or cell phones. The acquisition function of the GPS receiver is improved by inserting new signal processing for broadband noise reduction that allows subsequent improved estimation of critical time shift and frequency shift parameters needed for GPS acquisition at lower received signal levels. The decoding of the navigation bits from the satellite transmissions is improved to provide ephemeris data needed for computing navigation solutions at lower received signal levels, by examining the output of the same new signal processing for broadband noise reduction for spikes in the power of the output time series that correspond to navigation bit flips.

### CROSS REFERENCE TO RELATED APPLICATIONS

This application claims the benefit of U.S. Provisional Application No. 60/838,258 filed Aug. 17, 2006 for which priority is claimed and whose disclosure is incorporated by reference.

### FIELD OF THE INVENTION

The present invention is directed to a global positioning system (GPS), and more particularly to a GPS system having improved signal-to-noise ratio for reducing the required signal level for which GPS may be implemented in hand-held electronic devices or cell phones.

### BACKGROUND OF THE INVENTION

The United States Global Positioning System (GPS) is used extensively throughout the world for estimating the position of a receiver in terms of latitude, longitude, and elevation on the earth, and for navigation. Development efforts in GPS implementation have focused on packaging, miniaturization and cost reduction for commercial applications, e.g., hand-held electronic devices. In the area of GPS performance, the major thrust is to increase the sensitivity of the GPS receiver so that it can acquire satellite signals at the reduced signal levels associated with covered environments, such as under tree canopies or indoors. A major driver for this development is legislation in the United States requiring that all cell phones must soon be able to provide localization information with 911 calls.

Since emergency situations frequently occur indoors, this has spurred great interest in improving the sensitivity of GPS to be able to acquire and process satellite information at lower signal levels. The most severe condition is a “cold start”, wherein the GPS receiver is turned on with no information regarding the satellites or its location. A “warm start” is a reacquisition of the satellite data with the benefit of previous track and satellite information, for example when an outdoor track is dropped as the receiver is brought indoors. Warm starts require less signal strength than cold starts. Assisted GPS (AGPS) is a mode of operation that reduces the amount of data that needs to be estimated by the receiver by providing that information via an auxiliary communications link. AGPS requires less computation since the supplied information reduces the search space for acquisition, and can be performed at a lower signal level than a cold start. Another variable is the time to first fix (TTFF), which is reduced dramatically if assist data from other ground communications links can be made available to the GPS receiver.

The entire area of development collectively denoted by High Sensitivity GPS (HSGPS) has concentrated on the added signal processing complexity that could provide operation in these adverse environments that have reduced GPS signal levels.

GPS is a space-based localization system that operates on signals received from satellite transmitters. It is thus a “passive” system, in that it operates entirely on received rather than transmitted and reflected energy, and is therefore available for use by anyone who has the needed receiver equipment. Each satellite in the GPS system is called a space vehicle (SV) and transmits a GPS signal to the ground. The data or information contained in this signal is called navigation, or NAV data, digitally encoded in bits called NAVbits. It contains GPS timing or clock correction data, satellite location or “ephemeris” information, other data related to propagation conditions such as ionospheric data, and almanac data related to the orbits of all of the SVs. All of this information is coordinated between all of the SVs and central ground control stations operated by the US Government for the entire GPS network. The receiver needs to lock on to signals from a minimum of four SVs to unambiguously solve the geometric equations that locate its position on the earth. Most receivers simultaneously scan for between eight and twenty possible satellites.

A major function of the signal acquisition processing in GPS is to extract and estimate two specific pieces of data from each SV: 1) the time alignment, which will be denoted as a time shift, of the unique code sequence from each SV, and 2) the frequency or Doppler shift of the carrier frequency caused by relative motion between the SV and the receiver. Assisted GPS restricts the region of time and frequency shifts over which search is required by utilizing approximate satellite localization information provided by the ephemeris data through some form of communication link.

Improvements in operation at reduced signal levels such as indoors and under trees have concentrated on using multiple frequencies simultaneously as in military systems, and launching new satellites with increased transmission power levels. Even with these improvements there is always a need to detect lower signal levels for both civilian and military systems.

### SUMMARY OF THE INVENTION

The present invention changes the signal processing in GPS to operate at lower received signal levels. By operating at lower received signal levels, the GPS system is able to achieve cold starts, warm starts, and assisted GPS faster and in conditions at which they could not otherwise be achieved. This allows the user greater flexibility in the conditions under which the GPS is used. The GPS, whether stand alone or in a cell phone, provides positional information faster and in conditions such as under tree canopies and indoors, where operation would not be possible with existing GPS processing approaches. The present approach may be implemented in application specific hardware, programmable digital signal processors, or a mixture of both as might be appropriate.

One of the innovations is improving the acquisition function of the GPS receiver. It does this by inserting new signal processing for broadband noise reduction that allows subsequent improved estimation of critical time shift and frequency shift parameters needed for GPS localization at lower received signal levels.

Another innovation is improving the decoding of the navigation bits from the satellite transmissions to provide ephemeris data needed for computing navigation solutions at lower received signal levels. It does this by examining the output of the same new signal processing for broadband noise reduction for discontinuities in the output time series that correspond to navigation bit changes.

In one embodiment, the invention is directed to a method for GPS signal processing that enables GPS signal acquisition at reduced received signal power levels. This is done by sensing GPS signals from a plurality of satellites through an antenna and preamplifier, receiving the GPS signals from the antenna in an radio frequency or RF stage, and then down converting the GPS signals from RF to intermediate (IF) frequencies in a down converter. The resulting IF GPS signals are then converted to digital GPS signals in an analog-to-digital converter (A/D) for input to a digital signal processor or DSP. The processing in the DSP takes several steps. First the digital GPS signals are buffered into a time block for decoding by multiplying the buffered digital GPS signals by a coarse acquisition (C/A) code that has been concatenated over a time interval that matches the buffered block of time sampled digital GPS signals, resulting in a decoded GPS signal. This is followed by filtering and decimating the decoded GPS signal in the digital signal processor to reduce the sample rate. At this point the reduced sample rate signal is processed to reduce the broadband noise component of the filtered and decimated decoded GPS digital signals. This is done by a process called Broadband Noise Reduction (BBNR) which employs adaptive filtering. The input to the adaptive filter is obtained by applying the reduced sample rate signal to a bulk delay to provide a delayed version of the reduced sample rate signal. This delayed version is processed in an adaptive filter, the output of which is then subtracted from the original undelayed reduced sample rate signal to generate an error signal. This error signal is fed back to the adaptive filter to iteratively adjust a plurality of filter weighting parameters in the adaptive filter to minimize the power in the error signal. This produces an adaptive filter output signal having a reduced level of the broadband noise component. Spectral analysis of the adaptive filter output signal is then performed to detect the shifted carrier frequency. The frequency shift is estimated by performing spectral bin-to-bin comparisons on a plurality of discrete frequency bins and selecting a peak spectral bin based on a greatest power value for all time shifts associated with the C/A codes, and comparing the greatest power value in the peak spectral bin to a threshold value. Associating the time shift of the C/A code and the frequency bin with greatest power value that exceeds the threshold results in the time shift estimate and frequency shift estimate. The time shift estimate and frequency shift estimate are then passed to a signal tracking function to produce a refined time shift estimate and a refined frequency shift estimate which is then passed to a navigation processor that combines the refined time shift estimate and the refined frequency shift estimate with ephemeris data to calculate a GPS location.

In another embodiment, the invention is directed to a method for GPS signal processing that improves navigation bit decoding. The approach is the same through the step of reducing the broadband noise component using the BBNR. Discontinuities in the BBNR output time waveform are then used to detect transitions in the navigation bits. This is done by detecting a plurality of negative spikes in the power of the time waveform of the adaptive filter output signal, and associating the occurrence of the detected spikes with a flip of the NAVbits from zero to one or from one to zero, and by associating the corresponding time of the spike with the time of the NAV bit flip. The NAVbits and the times associated with NAVbit flips are then passed to a navigation processor where the NAVbits are decoded into ephemeris data. The ephemeris data is used in navigational calculations to obtain a GPS location.

In another embodiment, the invention is directed to a method for GPS signal processing that performs both the time shift and frequency shift estimation along with the detection of navigation bit flips and combines them to improve both GPS signal acquisition and navigation bit decoding.

In another aspect, the invention is directed to a system for GPS signal processing. In a system implementation, hardware or software functions are provided for each of these steps.

This invention makes these changes in the digital signal processor portion of the receiver which will be described below in more detail.

The invention allows GPS operation at lower input signal levels and thereby improves the sensitivity sufficiently for the GPS to work in adverse environments where the received signal level is reduced, such as indoors, under trees, inside vehicles, in between tall buildings in inner city canyons, etc. This applies to all GPS operational modes such as cold start, warm start, and assisted GPS.

This invention improves the signal-to-noise ratio at which GPS will operate, by inserting new additional signal processing, thus making dramatic strides in High Sensitivity GPS performance. It may be implemented in application specific hardware, programmable digital signal processors, or a mixture of both as might be appropriate It does this with easily accommodated increases in processing complexity, such that it is well within the realm of inclusion in small, inexpensive implementations such as hand-held devices or cell phones.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a flow diagram of the method for time shift and frequency shift estimation for GPS acquisition;

FIG. 2 is a flow diagram of the method for GPS tracking and localization;

FIG. 3 is a flow diagram of the method for broadband noise reduction;

FIG. 4 is a flow diagram of the method for navigation bit decoding;

FIG. 5 is a flow diagram of the GPS receiver system;

FIG. 6 is a flow diagram of the system for time shift and frequency shift estimation for GPS acquisition;

FIG. 7 is a flow diagram of the system for GPS tracking and localization;

FIG. 8 is a flow diagram of the system for broadband noise reduction;

FIG. 9 is a flow diagram of the system for navigation bit decoding;

FIG. 10 is a performance example showing the decoding of NAVbits at the BBNR output;

FIG. 11 is a flow diagram of an implementation for relating typical parameter values; and

FIG. 12 is a performance example of GPS signal acquisition comparing performance of this invention with processing using alternative approaches.

### DETAILED DESCRIPTION OF THE INVENTION

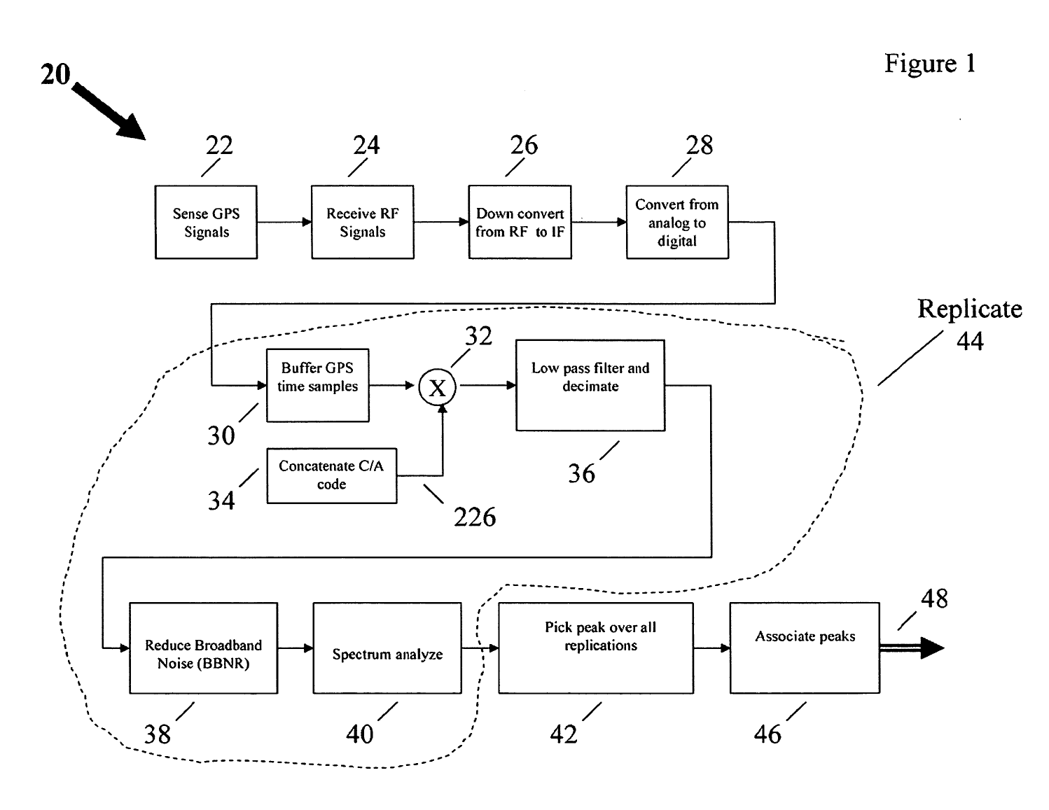

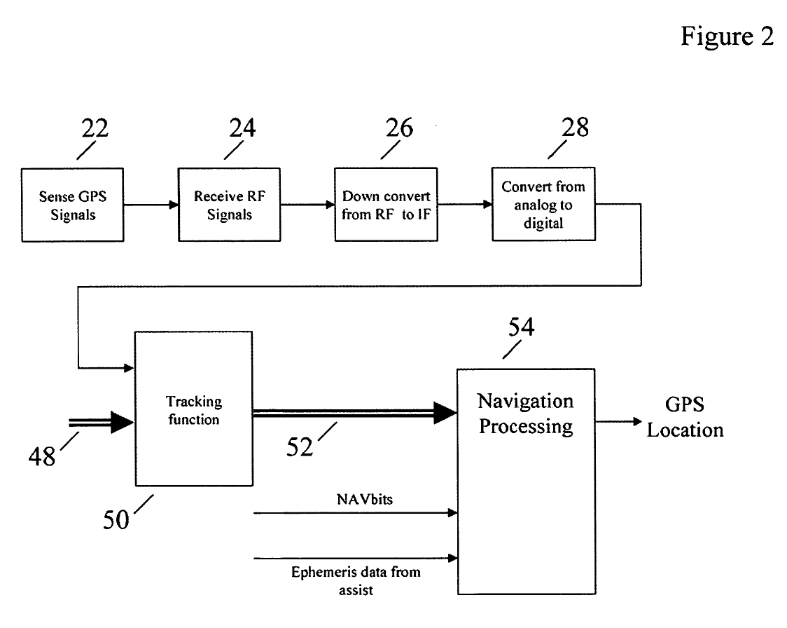

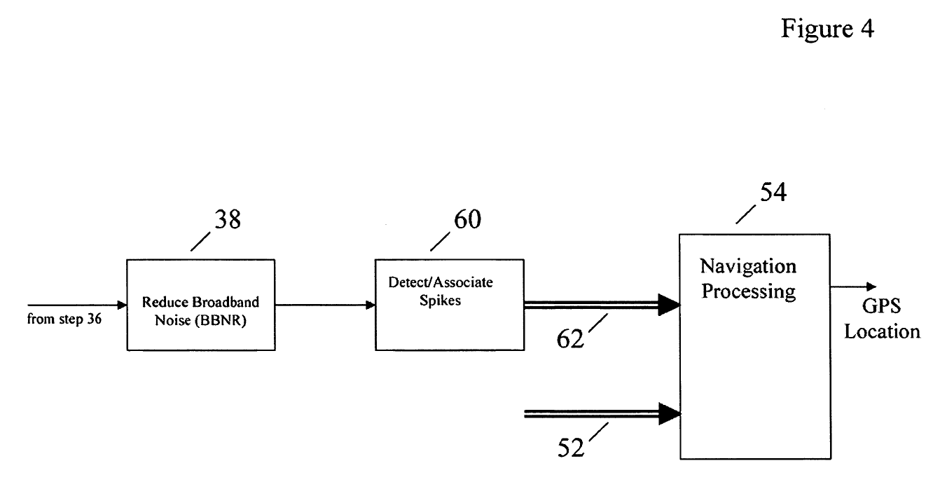

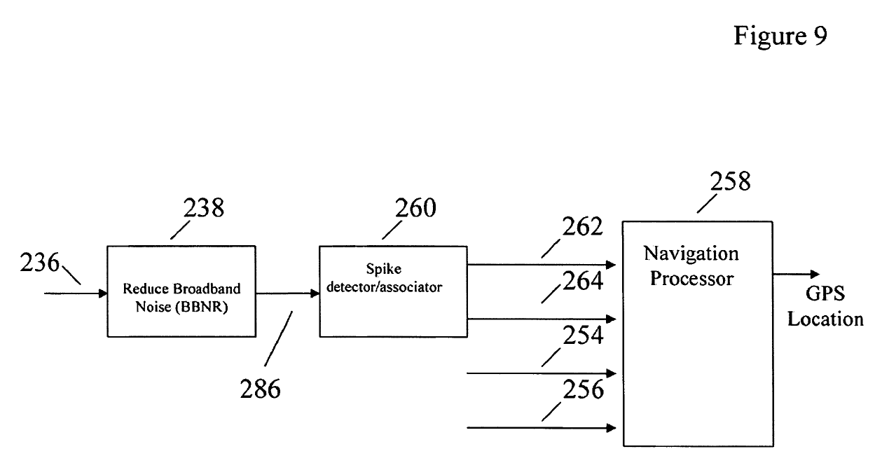

There are three important GPS signal processing functions addressed in this discussion: 1)signal acquisition, which is described in conjunction with FIGS. 1 and 6, 2) signal tracking, which is described in conjunction with FIGS. 2 and 7, and 3) navigation information bit decoding, which is described in conjunction with FIGS. 4 and 9.

The signal acquisition function is the estimation of the critical time and frequency shift parameters to accuracy adequate to allow subsequent code and carrier track loops to lock on and track dynamic time shifts and Doppler changes in the GPS signals. The signal tracking function is the dynamic tracking and refinement of the time shift and frequency shift estimates. The outputs of the signal acquisition function along with the input data are passed to the signal tracking function, which uses them to initialize the carrier and code tracking loops. To obtain a GPS location, the acquisition and tracking results are passed to a navigation processor, which combines the time shift and frequency shift estimates with ephemeris data. The navigation information bit decoding is needed by the navigation processor to estimate the ephemeris data from the SV transmissions, where it has been encoded in the NAVbits.

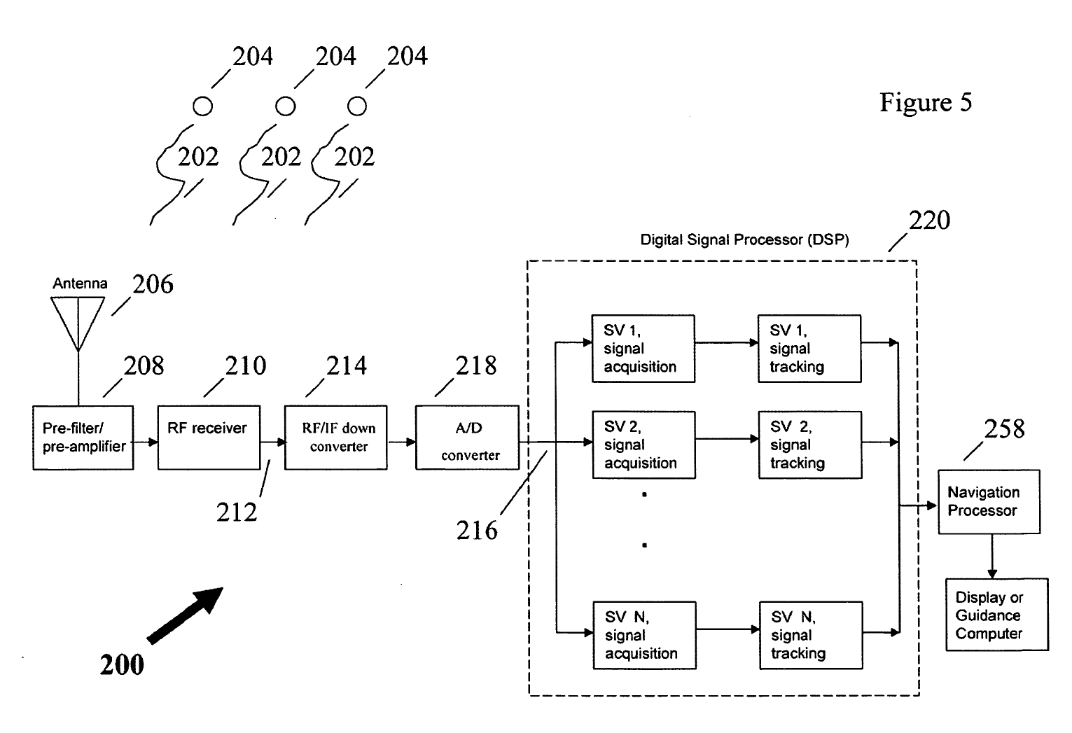

FIG. 1 depicts a method 20 for GPS signal processing, and FIG. 5 is a block diagram of a GPS receiver 200 that may be used in conjunction with the method 20. The method 20 comprises sensing analog GPS signals 202 from a plurality of GPS satellites 204 through an antenna 206, step 22 of FIG. 1. The antenna 206 that senses the GPS signals 202 may be integral with the remaining electronic components of the GPS receiver 200 that are discussed subsequently, or it may be separate from the other components. For minimal operation, the GPS receiver 200 receives the GPS signals 202 from at least four GPS satellites 204, and more preferably from at least six GPS satellites 204. The signals transmitted from each satellite 204, referred to in GPS systems as space vehicles (SVs), are differentiated from one another by spread spectrum encoding the navigation data with a different pseudo-random code, uniquely assigned to each SV.

The description of the invention will be illustrated using the civilian GPS. The GPS signal 202 from each GPS satellite 204 is different and contains unique coded information that is used in performing the method 20. The GPS signals 202 are typically of a frequency for civilian GPS called the L1 carrier, a single sinusoidal carrier that is transmitted from each SV at a frequency of 1575.42 MHz. The navigation information is encoded as a sequence of bits transmitted at a 50 Hz rate. The navigation data is multiplied (or logic exclusive OR'd) with the SV's pseudo-random noise code, which is a 1.023 MHz bit stream. The combined bit stream (NAVbits and code bits) is modulated onto the carrier by varying its phase for each information bit, using quadrature phase shift keying, or QPSK. The navigation data, which is encoded in bits of information called NAVbits, changes slowly and has a relatively small amount of information; it varies at a 50 Hz rate.

The data is multiplied (or applied using a logic exclusive OR function) with the SVs pseudo-random noise code. The modulating codes vary rapidly and thus occupy a broad frequency band relative to the NAV data. This spreads the spectral content over a broad band that provides very desirable properties with respect to jamming signals and multipath propagation, and also allows multiple users to occupy the same band and be distinguished from one another. The codes are carefully selected from the class of so called “Gold codes” which have low response when cross-correlated with one another, and very spiked response when autocorrelated with themselves. The spiked autocorrelation property is what is used to accurately estimate the relative time shift between the received modulated signal and the replica code in the receiver. The codes vary so rapidly that the delay steps between code chips are sufficiently small, and the value of time shift that provides code alignment is of a sufficiently high-resolution time value to provide time shift estimates.

A bank of correlators, or matched filters, is used to extract an estimate of the propagation time shift and the Doppler frequency shift. These matched filters correlate the received signal with replicas of the code for different time alignments and different frequency shifts, resulting in a large magnitude signal when the time shifts and frequency shifts are properly aligned.

Continuing the description of the invention using the civilian GPS, the codes are called the C/A (Coarse Acquisition) Codes. The C/A codes are 1.023 MHz Pseudo Random Noise (PRN) Codes which repeat every millisecond (or 1023 bits). This noise-like code modulates the 50 Hz NAVbits “spreading” the spectrum over approximately 1 MHz bandwidth. There is a different C/A code PRN for each SV. GPS satellites are often identified by their PRN number, the unique identifier for each pseudo-random-noise code.

Because antenna signals are generally weak, the output amplitude is scaled up using a preamplifier 208 that is usually part of the antenna hardware. The preamplifier output is input to a radio frequency (RF) receiver stage 210, which is hardware circuitry tuned to respond to the 1575.42 MHz satellite transmissions, step 24 of FIG. 1. The RF stage 210 passes the GPS signal 202 and has significantly lower response to energy in other bands.

The output signals 212 of the RF stage 210 are down-converted from RF to IF (intermediate frequencies, of about 5 MHz) in a down converter 214, step 26 of FIG. 1. The GPS signals 202 are down converted to achieve a waveform that has the smallest bandwidth that still contains all of the GPS information. This is because the analog waveforms are going to be sampled and digitized, and the sample rate is proportional to the inverse of the bandwidth of the data. Lowering the data bandwidth makes the time between samples larger and thus lowers the sample rate, so that the subsequent digital processing runs at the slowest possible rate. The down converter 214 is a conventional hardware device that can function in any operable manner, but typically operates by bandpass filtering and frequency shifting.

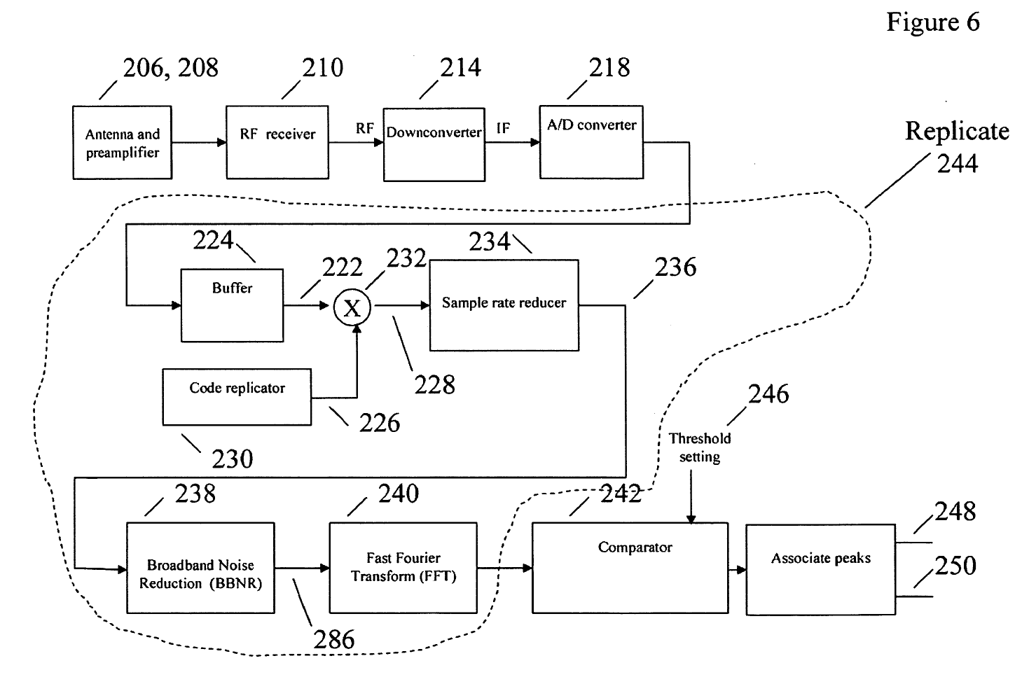

The analog IF GPS signals are converted in step 28 of FIG. 1 to digital GPS signals 216 in an analog-to-digital converter 218. The digital GPS signals 216 are input to a digital signal processor, 220. The digital signal processor 220 processes the digital GPS signals 216 through all of the multiple steps in FIGS. 1, 2, 3, and 4 that are between the A/D conversion step 28 and the separate Navigation Processing to be discussed subsequently. The structure of the digital signal processor 220 is illustrated in FIGS. 5 and 6. As used herein, digital signal processing may be a general purpose programmable processor using software instructions or application specific hardware or a combination of both.

The first operation in the digital signal processor 220 is to buffer the digital GPS signals 216 to obtain a block of time-sampled digital GPS signals 222, step 30 of FIG. 1.

The time-sampled digital GPS signals 222 are multiplied in the multiplier 232, step 32 of FIG. 1, by a coarse acquisition (C/A) code 226 to obtain a decoded GPS signal 228. The coarse acquisition code 226 is concatenated in the code replicator 230, over a time interval that matches the buffered block of time-sampled digital GPS signals 222, step 34 of FIG. 1. The C/A code 226 is concatenated—i.e., repeated multiple times—in order to match the length of time of the amount of sampled data in the time block buffer 224.

Since there is no need to run the subsequent digital processing at a higher rate than twice its bandwidth, the output 228 of the multiplier 232 is low pass filtered and decimated in step 36 of FIG. 1, in the sample rate reducer 234 to reduce the sample rate, producing a reduced sample rate signal 236.

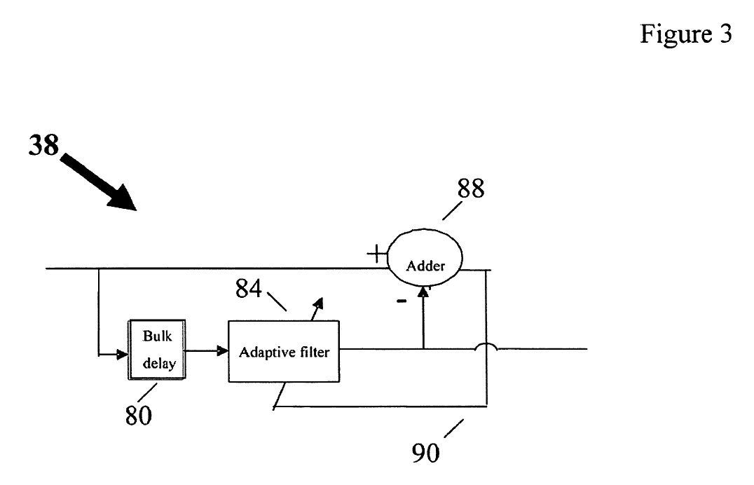

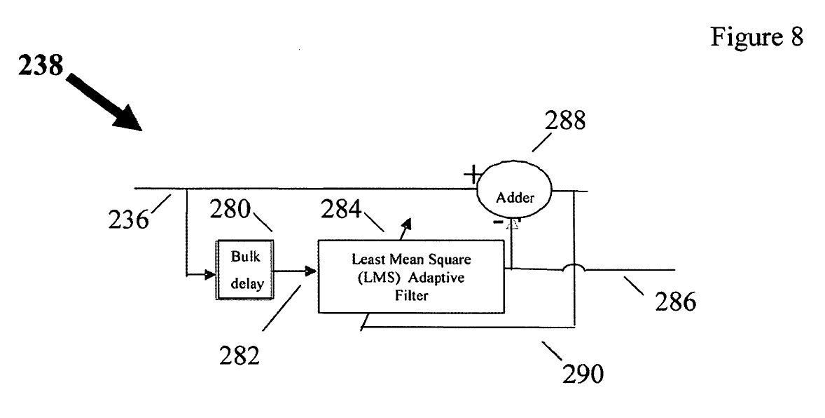

After the filtering and decimating step 36, the spectral level of the broadband noise component of the reduced sample rate GPS signal 236 is reduced, step 38 by a series of steps in the digital signal processor 220. This broadband noise reduction is indicated as step 38 of FIG. 1 and box 238 of FIG. 6. The details of the broadband noise reduction step 38 are illustrated in FIG. 3 and the details of the broadband noise reduction box 238 are illustrated in FIG. 8.

The reduced sample rate signal 236 is applied to a bulk delay 240, step 80, to provide a delayed version 282 of the reduced sample rate signal 236. In this step 80, a bulk delay predetermined amount of time is greater than the correlation time of the broadband noise component of the delayed version 282 of the reduced sample rate signal 236, and less than a correlation time of the GPS signal component of the reduced sample rate signal 236, such that the delayed signal broadband noise component is decorrelated. The delayed version 282 of the reduced sample rate signal 236 is correlated with respect to the GPS signal component of the undelayed reduced sample rate signal 236 which contains the GPS information.

The delayed version 282 of the reduced sample rate signal 236 is adaptively filtered, step 84 in FIG. 3, in an adaptive filter 284 to generate an adaptive filter output signal 286.

The adaptive filter output signal 286 is subtracted, step 88 in adder 288, from the undelayed reduced sample rate signal 236 to produce an error signal 290. The error signal 290 is fed back to the adaptive filter 284, step 90 in FIG. 3.

The adaptive filter 284 is a tapped delay line with weighting coefficients that scale the values of the digital waveform at each tap and then sum the plurality of filter weighted tap outputs. The weighting coefficients are iteratively adjusted in adaptive filter 284. The adaptive filter adjusts its transfer function to pass the correlated components of the reduced sample rate signal 236 and the delayed version of the reduced sample rate signal 282, and to reject the uncorrelated components of the reduced sample rate signal 236 and the delayed version of the reduced sample rate signal 282 to modify the adaptive filter output signal 286. The adaptive filter 284 preferably includes a least mean square (LMS) algorithm to iteratively adjust the plurality of filter weighting parameters in the adaptive filter 284 to minimize the power in the error waveform 290. The adaptive filter 284 in the BBNR processing block 238 employs a particular configuration of the Least Mean Square (LMS) Adaptive Filter, which is well known to those skilled in the art of signal filtering, and is described in detail in the textbook Adaptive Filters, Structures, Algorithms and Applications, by M. Honig and D.G. Messerschmitt, Kluwer Academic Publishers, Boston, USA 1984.

Returning to the flow diagram of FIG. 1, after the broadband noise reduction 38, a spectral analysis of the adjusted adaptive filter output signal 286 is performed, step 40 of FIG. 1. This spectral analysis detects the shifted carrier frequency by performing spectral bin-to-bin comparisons on a plurality of discrete frequency bins. The spectral analysis of the adjusted adaptive filter output signal 286 is preferably achieved using a Fast Fourier Transform (FFT) algorithm 240.

A peak spectral bin based on a greatest power value of all of the FFT bins computed over the plurality of replications for each possible time shift of the C/A code is picked, step 42, in a comparator 242. There is a replication 44 of the functions 30 through 42 in FIG. 1, and 244 of FIG. 6 for the corresponding system elements 224 through 240. This replication is for each possible time shift of the stored C/A code concatenated replicas. In one embodiment, the signal processing may be replicated in one-half chip time steps, until the code repeats. For current GPS C/A codes, the code repeats every 1024 chips. Thus there are usually 2048 versions of the signal acquisition processing in the replication 44 FIG. 1 and the replication 244 of FIG. 6 that are operating simultaneously. One of the 2048 versions will be within +/−½ chip of the actual code sequence and will effectively remove the spectral spreading induced by the C/A code modulation, resulting in the Doppler-shifted version of the basebanded carrier frequency modulated by the NAV bits Thus, the simultaneous processing removes the spectral spreading induced by the C/A code modulation, so the bandwidth is now that of the modulating data, which is much narrower. The greatest power value in all of the spectral bins is picked and compared with a threshold setting 246, in the step 42, in a comparator 242.

The method includes associating, step 46, a time shift of the C/A code and the frequency bin with the greatest power value that exceeds the threshold setting 246 to be, respectively, the time shift estimate 248 and the frequency shift estimate 250. The time shift estimate associated with the C/A code that aligned with the data is related to the propagation travel time from the satellite 204 to the GPS receiver 200. These output values of the signal acquisition function are passed to the signal tracking function

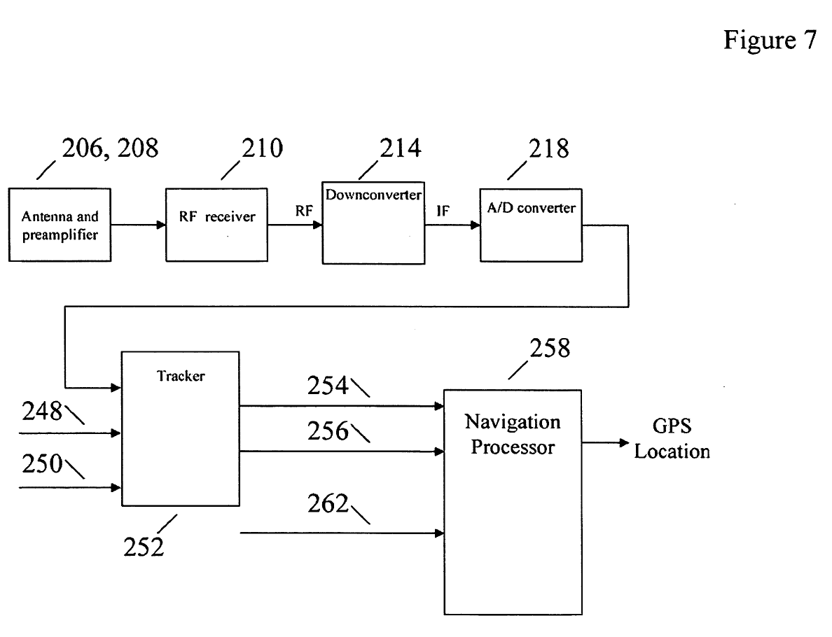

The time shift estimate 248 and the frequency shift estimate 250 are passed, step 48, to a signal tracking function 252 to produce in tracking step 50 of FIG. 2 a refined time shift estimate 254 and a refined frequency shift estimate 256 of FIG. 7. The signal tracking function 56 preferably is performed by initializing Delay Lock Loop and Phase Lock Loop trackers for refining and tracking changes in the time shift estimate 248 and the frequency shift estimate 250.

The refined time shift estimate 254 and the refined frequency shift estimate 256 are passed, step 52 of FIG. 2 from the signal tracking function 252 to a navigation processor 258 that combines the refined time shift estimate 254 and the refined frequency shift estimate 256 with ephemeris data 262 to calculate a GPS location, step 54. The ephemeris data 262 is either provided by an auxiliary communication path in assisted GPS, or is computed from the NAVbits which will be discussed subsequently. The combination of data in the navigation processor 258 is performed using well known geometric and physics equations as documented in textbook Understanding GPS. Principles and Applications, by E. D. Kaplan, Artech House Publishers, Boston USA 1996.

The approach in this invention also improves the bit decoding of the navigation information from the SV transmissions. This approach is illustrated in FIGS. 4 and 9. In this approach the steps 22-36 discussed above, and whose description is incorporated here, are repeated.

The method next includes detecting changes in the NAVbits and decoding the NAVbits by detecting discontinuities in the BBNR output 286, i.e., a plurality of negative spikes in the power in the time waveform of the adaptive filter output signal, step 60. The occurrence of the detected spikes is associated with a flip of the NAVbits from zero to one or from one to zero, and by associating a corresponding time of the spike with a boundary in time of the NAVbit flip. This allows the NAVbits to be decoded at lower signal levels than is required for conventional GPS processing. A particular BBNR (of the 2048 replicated versions) produces the best time alignment for estimating the time shifts 248 in FIG. 6. The output power of that particular BBNR process has a time waveform that will exhibit discontinuities (or spikes) at the times that correspond to the phase reversals of the QPSK encoding of the NAVbits onto waveforms transmitted from the SVs. Thus, by examining the output power of the new GPS processing as a function of time, the NAVbits can also be decoded. This corresponds to the cold start condition, where both the NAVbits need to be estimated (or decoded) and the time and frequency shifts need to be estimated, with no prior information.

NAVbit estimation is the most demanding GPS process in terms of requiring the largest signal level. Current GPS systems require approximately a signal level of −142 to −145 dBm to decode the NAVbits, even though the time and frequency shifts can be estimated conventionally at approximately −155 dBm. That is why cold start can only be done at between −142 to −145 dBm, while assisted GPS (AGPS) can operate at about −155 dBm.

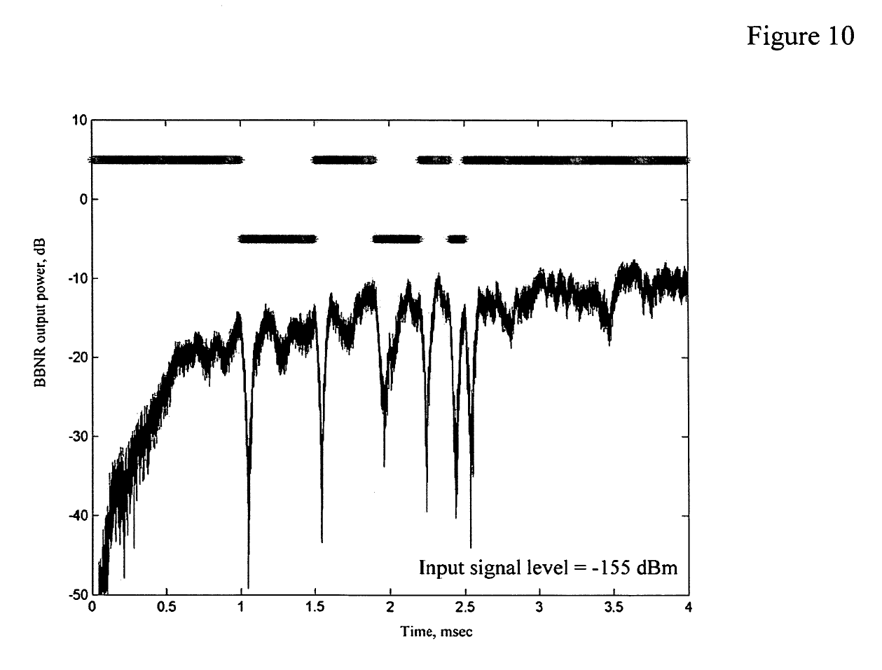

FIG. 10 illustrates this process using a simulation example. The received signal level used in this simulation is −155 dBm. This example shows that the use of the output of the BBNR processing allows NAVbit flips to be reliably detected at an input level signal level of −155 dBm, thereby allowing cold start performance with the new processing at about the same level as assisted acquisition can now be done without this invention. The upper horizontal lines in FIG. 10 represent the times at which the NAVbit is a one, and the lower horizontal lines are the times when the NAVbit is a zero. The power in the time waveform at the BBNR output is shown in the trace below the horizontal lines that represent the bit values, and at each change in the NAVbits there is a large detectable negative spike in the BBNR output power. The parameters used for the simulation are an input signal level is −155 dBm, and a 1000 tap adaptive filter with a bulk delay of 25 samples and a feedback coefficient of 0.001. Even at this low signal level there is 15-30 dB negative spike in the BBNR output power when NAVbit flips occur, enabling reliable detection of the NAVbit flips, thus eliminating the need for assisted GPS information to provide the ephemeris data.

The spike detector/associator 260 detects the occurrence of NAVbit flips 262 and associates the time at which they occur with the NAVbit boundaries, 264. The steps 60 are performed in the DSP 220. The detected NAVbits are then passed 62 to the navigation processor 258, where the NAVbits are decoded into a set of ephemeris data. The ephemeris data are used in the navigational calculations described earlier to obtain the GPS location.

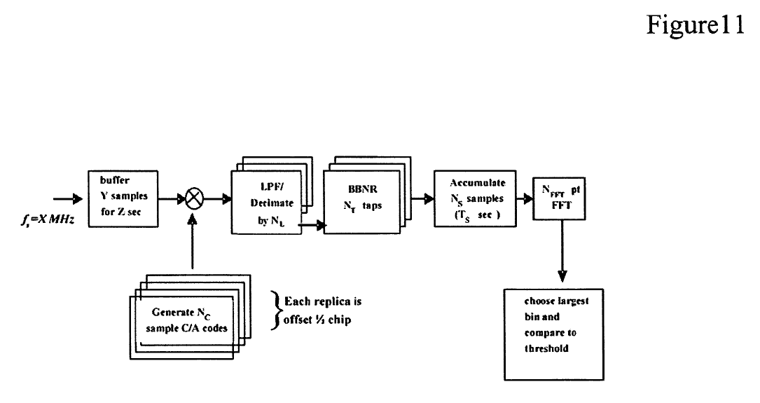

Referring to FIG. 11, parameter values are presented for a way to implement the new method for GPS acquisition processing employing broadband noise reduction (BBNR). Typical values for the parameters in FIG. 11 are provided below, but it will be appreciated by those skilled in the art that these values are exemplary, and will vary depending upon particular implementations. These exemplary values are in a midrange of values in which they may be applied, while still achieving the gains provided by the invention. For example, the quantity Y samples are accumulated for the quantity Z seconds.

Accumulating Y samples of input data for Z between 20 and 1000 milliseconds at a typical GPS sample rate of 5 MHz corresponds to a value of Y between 100,000 and 5,000,000 samples. Other embodiments may accumulate samples over a larger or smaller time block, which will adjust the values for number of samples and sample rate accordingly. The sample C/A code is concatenated to correspond to the time samples stored in the input buffer 224. The Low Pass Filtering and Decimation function 234 reduces the bandwidth and the corresponding sample rate at which the BBNR 238 operates, to the bandwidth and sample rate of the spectral information in the GPS signal. The sample rate reducer 234 is here implemented using low pass filtering and decimation, but may be applied in various configurations of one or more stages, so long as the configurations produce equivalent results.

In the specific case shown in FIG. 11, if the input data sample rate fₛ=5 MHz, then the following parameter values are representative of the range for which BBNR improvements are shown in the subsequent examples:
Y=100,000 to 5,000,000 samples
Z=20 to 1,000 msec
N_{L}=100, the factor of bandwidth decimation
N_{T}=1000 taps in the adaptive filter
N_{S}=1000 samples accumulated for T_{S}=1 sec of averaging
N_{FFT algorithm}=1024 points in the Fast Fourier Transform

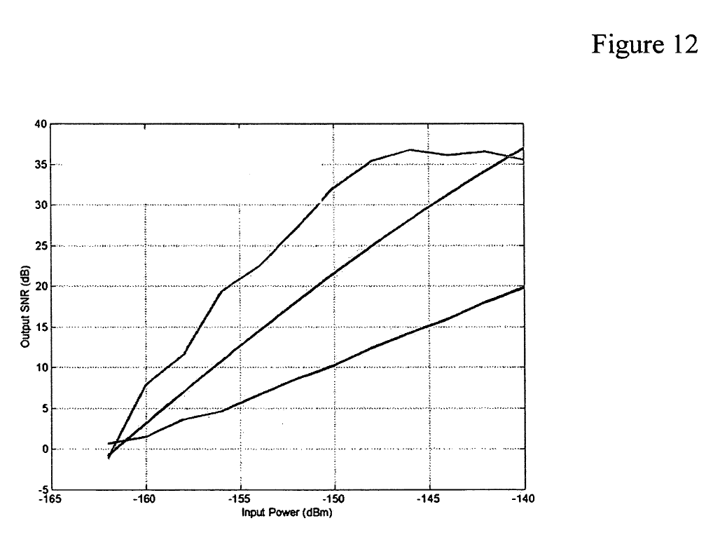

FIG. 12 shows an example of a comparison of acquisition performance over a wide range of input signal levels between the new GPS processing using BBNR in this invention as compared with the way GPS systems operate without it. Cold start performance has already been discussed in the example of FIG. 10, which simulated the method of FIG. 4 for decoding NAVbit information from the SV transmission. This example considers assisted GPS to demonstrate acquisition performance, and is simulated in FIG. 12. Providing ephemeris data to the acquisition process in assisted GPS rather than requiring that it be decoded from the NAVbits in a cold start reduces the range of frequencies over which the acquisition process needs to search. The bandwidth is cut in this case to about 2 KHz.

During the acquisition processing the NAVbits are assumed to be flipping between zeros and ones, but the NAVbits are not decoded because they are already provided in decoded form via an assist information path. So the effects of random bit flips are present, but the DSP is not decoding the information in the bit flips. This also allows increasing the coherent processing time. In this example processing takes place over approximately a 2.5 sec period, so some prediction is required to compensate for satellite motion over that interval of time. Any GPS operating over that time interval would have to perform a similar prediction, and it is assumed that it is done here in the same way. A single satellite only is simulated in this example. The conditions that apply for the performance simulations in FIG. 12 are as follows: Acquisition is being performed in assisted GPS mode, and the bandwidth for acquisition is 2 KHz. NAVbit flips are being dealt with, i.e., they are occurring during the processing interval, but Navbits are not being decoded. For the processing time of 2.5 seconds, satellite motion prediction (compensation) for a single satellite is assumed. The background thermal noise power density spectral level is the Boltzmann constant, k, times the black sky temperature, T, such that kT=−174 dBm (per Hz) which corresponds to a noise power of −141 dBm in the 2 KHz processing band. The Input signal power for the simulated cases is varied from −140 dBm to −162 dBm, which corresponds to input signal-to-noise power ratios varying from 1 dB for the signal level of −140 dBm to −21 dB for the signal level of −162 dBm. The output SNR is measure of the performance of the peak picking operation 42 of FIG. 1. It is assumed that a ratio of at least 5 to 10 dB of the peak to the surrounding levels is needed to achieve reliable detection of the peak, and the output SNR is the mean ratio of the peak signal to the highest surrounding level over 10 realizations. The probability of a NAVbit being a one on any bit is assumed to be Prob (NAVbit=1)=0.7, which corresponds to a probability of NAVbit flip occurring, Prob (NAVbit flip)=0.42, which is a reasonable representation of the information content in the NAVbits.

Three cases are compared in FIG. 12. The BBNR operates over 2.5 seconds, of which 1 second is coherent processing and the remainder of the time interval is non-coherent averaging to smooth the results, shown in the upper trace of FIG. 12. Since BBNR uses 2.5 seconds, the data was compared with conventional processing operating over the same time. The theoretical curve, indicated by the center trace of FIG. 12 represents the performance of 10 msec correlator outputs that are then non-coherently combined for the full 2.5 secs. Because only 10 msecs is processed, no bit flips occur in that interval. The lower curve of FIG. 12 corresponds to allowing the FFT algorithm without the BBNR pre-processor to operate coherently over the 2.5 sec interval. In this case the coherent processing is going to be degraded by random NAVbit flips. The result is that in conventional processing the bit flips degrade the coherence significantly. The addition of the BBNR pre-processing to conventional processing enables recovery of more of the coherent gain through the bit flips. The output signal-to-noise ratio for the BBNR case exceeds 5 dB at −161 dBm input signal level. The GPS without BBNR requires an input signal level of −157 dBm to achieve equivalent performance.

In terms of absolute signal levels, the following has been demonstrated for the use of BBNR to improve GPS performance: 1) the simulation examples in FIG. 12 show that assisted GPS can operate down to −161 dBm with BBNR where current assisted systems without BBNR cannot operate at signal levels below −157 dBm, and 2) the simulation example in FIG. 10, shows cold start performance with both acquisition (to provide the time delay and frequency shift estimates for tracking) and NAVbit detection (to provide the decoding of ephemeris information from the SV transmissions) can be performed at −155 dBm, compared to between −142-145 dBm without this invention.

While the invention has been described with reference to a preferred embodiment, it will be understood by those skilled in the art that various changes may be made and equivalents may be substituted for elements thereof without departing from the scope of the invention. As used herein, digital signal processing may be a general purpose programmable processor using software instructions or application specific hardware or a combination of both. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method for GPS signal processing comprising:
sensing GPS signals from a plurality of satellites through an antenna and preamplifier;
receiving the GPS signals from the antenna and preamplifier in an RF stage;
down converting the GPS signals from RF to IF frequencies in a down converter;
converting the IF GPS signals to digital GPS signals in an analog-to-digital converter (A/D);
inputting the digital GPS signals to a digital signal processor;
buffering the digital GPS signals in the digital signal processor to obtain a block of time sampled digital GPS signals;
multiplying the block of time sampled digital GPS signals by a coarse acquisition (C/A) code in the digital signal processor to obtain a decoded GPS signal, the C/A code being concatenated over a time interval that matches the buffered block of time sampled digital GPS signals;
filtering and decimating the decoded GPS signal in the digital signal processor to reduce the sample rate to produce a reduced sample rate signal;
reducing a broadband noise component of the reduced sample rate signal by:
applying the reduced sample rate signal to a bulk delay to provide a delayed version of the reduced sample rate signal,
adaptively filtering the delayed version of the reduced sample rate signal in an adaptive filter to generate an adaptive filter output signal,
subtracting the adaptive filter output signal from the reduced sample rate signal to generate an error signal,
feeding back the error signal to the adaptive filter, and
iteratively adjusting a plurality of filter weighting parameters in the adaptive filter in response to the error signal to modify the adaptive filter output signal having a reduced level of the broadband noise component;
performing spectral analysis of the adaptive filter output signal to detect a shifted carrier frequency by performing spectral bin-to-bin comparisons on a plurality of discrete frequency bins;
selecting a peak spectral bin based on a greatest power value for all time shifts associated with the C/A codes, and comparing the greatest power value in the peak spectral bin to a threshold value;
associating the time shift of the C/A code and the frequency bin with greatest power value that exceeds the threshold, to be the time shift estimate and frequency shift estimate;
passing the time shift estimate and frequency shift estimate to a signal tracking function to produce a refined time shift estimate and a refined frequency shift estimate; and
passing the refined time shift estimate and the refined frequency shift estimate from the signal tracking function to a navigation processor that combines the refined time shift estimate and the refined frequency shift estimate with ephemeris data to calculate a GPS location.

2. The method of claim 1, wherein the step of adaptively filtering includes providing an adaptive filter that uses a Least Mean Square (LMS) algorithm to iteratively adjusting a plurality of filter weighting parameters in the adaptive filter.

3. The method of claim 1, wherein the bulk delay predetermined amount of time is greater than the correlation time of the broadband noise component of the delayed version of the reduced sample rate signal, and less than a correlation time of the GPS signal component of the reduced sample rate signal, such that the delayed signal broadband noise component is decorrelated, and the delayed version of the GPS signal portion of the reduced sample rate signal is correlated with respect to the reduced sample rate signal.

4. The method of claim 1, wherein the step of iteratively adjusting a plurality of filter weighting parameters in the adaptive filter further includes developing a transfer function that passes the GPS signal portion of the reduced sample rate signal while lowering the broadband noise component of the reduced sample rate signal.

5. The method of claim 1, wherein the time shift is used to estimate the value of the propagation travel time from the satellite to the GPS receiver.

6. The method of claim 1, wherein the signal tracking function includes the step of using Delay Lock Loops (FLL) and Phase Lock Loops (PLL) for refining and tracking changes in the time shift estimate and the frequency shift estimate.

7. The method of claim 1, wherein the step of performing spectral analysis of the adaptive filter output signal is achieved by using a Fast Fourier Transform (FFT) algorithm.

8. The method of claim 1, further including replicating, for each of the plurality of time shifts of the C/A code, all of the digital signal processing steps in claim 1 up to and including spectrum analysis.

9. The method of claim 8, wherein the step of replicating is performed in one-half C/A code bit chip time steps, until the C/A code repeats.

10. The method of claim 9, wherein the step of multiplying by the C/A code time-shifted replicas reduces the bandwidth of the digital GPS signals and removes the spectral spreading induced by the C/A code modulation.

11. The method of claim 9, wherein the C/A code repeats every 1024 bit chips, and use ½ bit chip shifts to generate 2048 versions of the C/A code being concatenated over a time interval that matches the buffered block of time sampled digital GPS signals

12. A method for GPS signal processing comprising:
sensing GPS signals from a plurality of satellites through an antenna and preamplifier;
receiving the GPS signals from the antenna and preamplifier in an RF stage;
down converting the GPS signals from RF to IF frequencies in a down converter;
converting the IF GPS signals to digital GPS signals in an analog-to-digital converter (A/D);
inputting the digital GPS signals to a digital signal processor;
buffering the digital GPS signals in the digital signal processor to obtain a block of time sampled digital GPS signals;
multiplying the block of time sampled digital GPS signals by a coarse acquisition (C/A) code in the digital signal processor to obtain a decoded GPS signal, the C/A code being concatenated over a time interval that matches the buffered block of time sampled digital GPS signals;
filtering and decimating the decoded GPS signal in the digital signal processor to reduce the sample rate to produce a reduced sample rate signal;
reducing a broadband noise component of the reduced sample rate signal by:
applying the reduced sample rate signal to a bulk delay to provide a delayed version of the reduced sample rate signal,
adaptively filtering the delayed version of the reduced sample rate signal in an adaptive filter to generate an adaptive filter output signal,
subtracting the adaptive filter output signal from the reduced sample rate signal to generate an error signal,
feeding back the error signal to the adaptive filter, and
iteratively adjusting a plurality of filter weighting parameters in the adaptive filter in response to the error signal to modify the adaptive filter output signal having a reduced level of the broadband noise component;
detecting flips in the NAV bits and decoding the NAV bits by detecting a plurality of negative spikes in a short time power estimate of the time waveform of the adaptive filter output signal, and associating the occurrence of the detected spikes with a change of the NAVbits from a zero to a one or from a one to zero, and by associating a corresponding time of the spike with a boundary in time of the NAV bit shift; and
passing the NAVbits to a navigation processor where the NAV bits are decoded into a set of ephemeris data, the ephemeris data being used in navigational calculations to obtain a GPS location.

13. The method of claim 12, wherein the step of adaptively filtering includes providing an adaptive filter that uses a Least Mean Square (LMS) algorithm to iteratively adjusting a plurality of filter weighting parameters in the adaptive filter.

14. The method of claim 12, wherein the bulk delay predetermined amount of time is greater than the correlation time of the broadband noise component of the reduced sample rate signal, and less than a correlation time of the GPS signal component of the reduced sample rate signal, such that the delayed signal broadband noise component is decorrelated, and the GPS signal portion of the delayed version of the reduced sample rate signal is correlated with respect to GPS signal portion of the reduced sample rate signal.

15. The method of claim 12, wherein the step of iteratively adjusting a plurality of filter weighting parameters in the adaptive filter further includes developing a transfer function that passes the GPS signal portion of the reduced sample rate signal while lowering the broadband noise component of the reduced sample rate signal.

16. A method for GPS signal processing comprising:
sensing GPS signals from a plurality of satellites through an antenna and preamplifier;
receiving the GPS signals from the antenna and preamplifier in an RF stage;
down converting the GPS signals from RF to IF frequencies in a down converter;
converting the IF GPS signals to digital GPS signals in an analog-to-digital converter (A/D);
inputting the digital GPS signals to a digital signal processor;
buffering the digital GPS signals in the digital signal processor to obtain a block of time sampled digital GPS signals;
multiplying the block of time sampled digital GPS signals by a coarse acquisition (C/A) code in the digital signal processor to obtain a decoded GPS signal, the C/A code being concatenated over a time interval that matches the buffered block of time sampled digital GPS signals;
filtering and decimating the decoded GPS signal in the digital signal processor to reduce the sample rate to produce a reduced sample rate signal;
reducing a broadband noise component of the reduced sample rate signal by:
applying the reduced sample rate signal to a bulk delay to provide a delayed version of the reduced sample rate signal,
adaptively filtering the delayed version of the reduced sample rate signal in an adaptive filter to generate an adaptive filter output signal,
subtracting the adaptive filter output signal from the reduced sample rate signal to generate an error signal,
feeding back the error signal to the adaptive filter, and
iteratively adjusting a plurality of filter weighting parameters in the adaptive filter in response to the error signal to modify the adaptive filter output signal having a reduced level of the broadband noise component;
performing spectral analysis of the adaptive filter output signal to detect a shifted carrier frequency by performing spectral bin-to-bin comparisons on a plurality of discrete frequency bins;
selecting a peak spectral bin based on a greatest power value for all time shifts associated with the C/A codes, and comparing the greatest power value in the peak spectral bin to a threshold value;
associating the time shift of the C/A code and the frequency bin with greatest power value that exceeds the threshold, to be the time shift estimate and frequency shift estimate;
passing the time shift estimate and frequency shift estimate to a signal tracking function to produce a refined time shift estimate and a refined frequency shift estimate; and
passing the refined time shift estimate and the refined frequency shift estimate from the signal tracking function to a navigation processor that combines the refined time shift estimate and the refined frequency shift estimate with ephemeris data to calculate a GPS location.
detecting flips in the NAV bits and decoding the NAV bits by detecting a plurality of negative spikes in a short time power estimate of the time waveform of the adaptive filter output signal, and associating the occurrence of the detected spikes with a change of the NAVbits from a zero to a one or from a one to zero, and by associating a corresponding time of the spike with a boundary in time of the NAV bit shift; and
passing the NAVbits to a navigation processor where the NAV bits are decoded into a set of ephemeris data, the ephemeris data being used in navigational calculations to obtain a GPS location.

17. A method for GPS signal processing comprising:
sensing GPS signals from a plurality of satellites through an antenna and preamplifier;
receiving the GPS signals from the antenna and preamplifier in an RF stage;
down converting the GPS signals from RF to IF frequencies;
buffering the GPS signals to obtain a block of time-sampled GPS signals
multiplying the block of time-sampled GPS signals by a concatenated coarse acquisition code to obtain a decoded GPS signals;
modifying the decoded GPS signal to produce a reduced sample rate signal having a reduced sample rate relative to the decoded GPS signal;
reducing the spectral level of the broadband noise component of the reduced sample rate GPS signal by broadband noise reduction filtering the reduced sample rate GPS signal to produce an broadband noise reduced filtered signal;
spectrally analyzing the broadband noise reduced filtered signal;
obtaining a time-shift estimate and a frequency shift estimate from the spectrally analyzed broadband noise reduced filtered signal;
refining the time shift estimate and the frequency shift estimate; and
passing the refined time shift estimate and the refined frequency shift estimate to a navigation processor that utilizes the refined time shift estimate and the refined frequency shift estimate to calculate a GPS location.

18. A method for GPS signal processing comprising:
sensing GPS signals from a plurality of satellites through an antenna and preamplifier;
receiving the GPS signals from the antenna and preamplifier in an RF stage;
down converting the GPS signals from RF to IF frequencies;
buffering the GPS signals to obtain a block of time-sampled GPS signals
multiplying the block of time-sampled GPS signals by a concatenated coarse acquisition code to obtain a decoded GPS signals;
modifying the decoded GPS signal to produce a reduced sample rate signal having a reduced sample rate relative to the decoded GPS signal;
reducing the spectral level of the broadband noise component of the reduced sample rate GPS signal by broadband noise reduction filtering the reduced sample rate GPS signal to produce a broadband noise reduced filtered signal;
spectrally analyzing the broadband noise reduced filtered signal;
obtaining a time-shift estimate and a frequency shift estimate from the spectrally analyzed broadband noise reduced filtered signal;
refining the time shift estimate and the frequency shift estimate;
detecting flips in the NAVbits and decoding the NAVbits by analysis of spikes in a short-time power estimate of the time waveform of the broadband noise reduced filter output signal; and
passing the NAVbits and the refined time shift estimate and the refined frequency shift estimate to a navigation processor that utilizes the refined time shift estimate and the refined frequency shift estimate and the NAVbits to calculate a GPS location.

19. A system for GPS signal processing comprising:
an antenna tuned for receiving GPS signals from satellite vehicles;
a preamplifier to scale the GPS signals providing a preamplified GPS signal;
an RF filter and down converter, to convert the preamplified GPS signal from an RF GPS signal to an IF GPS signal;
an analog-to-digital converter configured to convert the IF GPS signal to a digital GPS signal; and
a digital signal processor including:
a buffer and a multiplier element configured to correlate the digitized GPS signal with a plurality of time shifted versions of the coarse acquisition (C/A) code forming a plurality of decoded GPS signals for each time shift,
a frequency shift estimation portion for processing the output of the multiplier element, the frequency shift estimation portion including:
a sample rate reducer, a broadband noise reduction (BBNR) processor followed by an FFT algorithm, and a threshold comparator portion,
the BBNR processor implementing an LMS adaptive filter consisting of a tapped delay line with weightings on each tap in the tapped delay line followed by summation of the weighted tapped delay line outputs to produce an adaptive filter output, where the weightings on each tap are updated in time using the LMS adaptive filter algorithm,
the BBNR processor configured to reduce the broadband noise level of the multiplier output by using a delayed version of the multiplier output as the input to the LMS adaptive filter and multiplier output itself as the reference in the LMS adaptive filter algorithm,
a spectral analysis processor using the FFT algorithm configured to estimate a frequency value at which a peak value occurs in the FFT output for each of the plurality time shifts of the C/A code at the multiplier input,
and the threshold comparator portion configured to select a peak value of all FFT outputs and all C/A code time shifts that exceeds a threshold value, and associating the time shift estimate and the frequency shift estimate with the combination of time shifts of the C/A code and the FFT frequency that produces the overall peak value,
a tracker portion that refines the time shift estimate and the frequency shift estimate; and
the navigation portion which computes a GPS location from the refined time shift estimate and the refined frequency shift estimate along with ephemeris data .

20. A system for GPS signal processing comprising:
an antenna tuned for receiving GPS signals from satellite vehicles;
a preamplifier to scale the GPS signals providing a preamplified GPS signal;
an RF filter and down converter, to convert the preamplified GPS signal from an RF GPS signal to an IF GPS signal;
an analog-to-digital converter configured to convert the IF GPS signal to a digital GPS signal; and
a digital signal processor including:
a buffer and a multiplier element configured to correlate the digitized GPS signal with a plurality of time shifted versions of the coarse acquisition (C/A) code forming a plurality of decoded GPS signals for each time shift,
a frequency shift estimation portion for processing the output of the multiplier element, the frequency shift estimation portion including:
a sample rate reducer, a broadband noise reduction (BBNR) processor followed by an FFT algorithm, and a threshold comparator portion,
the BBNR processor implementing an LMS adaptive filter consisting of a tapped delay line with weightings on each tap in the tapped delay line followed by summation of the weighted tapped delay line outputs to produce an adaptive filter output, where the weightings on each tap are updated in time using the LMS adaptive filter algorithm,
the BBNR processor configured to reduce the broadband noise level of the multiplier output by using a delayed version of the multiplier output as the input to the LMS adaptive filter and multiplier output itself as the reference in the LMS adaptive filter algorithm,
a processor that estimates the bit values and the bit change times of the ephemeris data encoded in the RF signals from each satellite by implementing the following:
a processor detecting flips in the NAV bits and decoding the NAV bits by detecting a plurality of spikes in a short time power estimate of the time waveform of the adaptive filter output signal, and associating the occurrence of the detected spikes with a flips of the NAVbits from a zero to a one or from a one to zero, and by associating a corresponding time of the spike with a boundary in time of the NAV bit flip; and
a connection that passes the NAVbits to a navigation processor where the NAV bits are decoded into a set of ephemeris data, the ephemeris data being used in navigational calculations to obtain a GPS location.

21. A system for GPS signal processing comprising:
an antenna tuned for receiving GPS signals from satellite vehicles;
a preamplifier to scale the GPS signals providing a preamplified GPS signal;
an RF filter and down converter, to convert the preamplified GPS signal from an RF GPS signal to an IF GPS signal;
an analog-to-digital converter configured to convert the IF GPS signal to a digital GPS signal; and
a digital signal processor including:
a buffer and a multiplier element configured to correlate the digitized GPS signal with a plurality of time shifted versions of the coarse acquisition (C/A) code forming a plurality of decoded GPS signals for each time shift,
a frequency shift estimation portion for processing the output of the multiplier element, the frequency shift estimation portion including:
a sample rate reducer, a broadband noise reduction (BBNR) processor followed by an FFT algorithm, and a threshold comparator portion,
the BBNR processor implementing an LMS adaptive filter consisting of a tapped delay line with weightings on each tap in the tapped delay line followed by summation of the weighted tapped delay line outputs to produce an adaptive filter output, where the weightings on each tap are updated in time using the LMS adaptive filter algorithm,
the BBNR processor configured to reduce the broadband noise level of the multiplier output by using a delayed version of the multiplier output as the input to the LMS adaptive filter and multiplier output itself as the reference in the LMS adaptive filter algorithm,
a spectral analysis processor using the FFT algorithm configured to estimate a frequency value at which a peak value occurs in the FFT output for each of the plurality time shifts of the C/A code at the multiplier input,
and the threshold comparator portion configured to select a peak value of all FFT outputs and all C/A code time shifts that exceeds a threshold value, and associating the time shift estimate and the frequency shift estimate with the combination of time shifts of the C/A code and the FFT frequency that produces the overall peak value,
a tracker portion that refines the time shift estimate and the frequency shift estimate; and
the navigation portion which computes a GPS location from the refined time shift estimate and the refined frequency shift estimate along with ephemeris data.
a processor that estimates the bit values and the bit change times of the ephemeris data encoded in the RF signals from each satellite by implementing the following:
a processor detecting flips in the NAV bits and decoding the NAV bits by detecting a plurality of spikes in a short time power estimate of the time waveform of the adaptive filter output signal, and associating the occurrence of the detected spikes with a flips of the NAVbits from a zero to a one or from a one to zero, and by associating a corresponding time of the spike with a boundary in time of the NAV bit flip; and
a connection that passes the NAVbits to a navigation processor where the NAV bits are decoded into a set of ephemeris data, the ephemeris data being used in navigational calculations to obtain a GPS location.
